(19) United States
(12) Patent Application Publication
(10) Pub. No.: US 2022/0401770 A1
(43) Pub. Date: Dec. 22, 2022

(54) FIRE SUPPRESSION SYSTEM FOR A BATTERY ENCLOSURE

(71) Applicant: Tyco Fire Products LP, Lansdale, PA (US)

(72) Inventors: Derek M. Sandahl, Wallace, MI (US); Alden A. Spencer, Marinette, WI (US); Kristin M. Ryczek, Oconto Falls, WI (US)

(73) Assignee: Tyco Fire Products LP, Lansdale, PA (US)

(21) Appl. No.: 17/774,468

(22) PCT Filed: Dec. 4, 2020
(86) PCT No.: PCT/IB2020/061533

§ 371 Date: May 4, 2022

Related U.S. Application Data
(60) Provisional application No. 62/944,226, filed on Dec. 5, 2019.

(51) Int. Cl. A62C 3/16; G08B 17/117; H01M 50/383; A62C 37/36

(52) U.S. Cl. CPC A62C 3/16; G08B 17/117; H01M 50/383; A62C 37/04

(57) ABSTRACT

A modular fire suppression unit includes a housing, an off-gas detector, a fire suppression apparatus, and a controller. The off-gas detector is provided within the housing and is configured to obtain air samples and detect a presence of off-gas in each air sample. The fire suppression apparatus is provided within the housing and configured to provide a fire suppression agent to a space. The controller is provided within the housing and is configured to receive signals from the off-gas detector indicating whether off-gas is detected in each of the air samples. The controller is also configured to activate the fire suppression apparatus to provide the fire suppression agent to the space in response to detecting off-gas in one or more of the air samples. The modular fire suppression unit is configured to be coupled to a sidewall of an enclosure.

### CROSS-REFERENCE TO RELATED PATENT APPLICATION

This application claims the benefit of and priority to U.S. Provisional Application No. 62/944,226, filed Dec. 5, 2019, the entire disclosure of which is incorporated by reference herein.

### BACKGROUND

Fire suppression systems are commonly used to protect an area and objects within the area from fire. Fire suppression systems can be activated manually or automatically in response to an indication that a fire is present nearby (e.g., an increase in ambient temperature beyond a predetermined threshold value, etc.). Once activated, fire suppression systems spread a fire suppression agent throughout the area. The fire suppressant agent then suppresses or controls (e.g., prevents the growth of) the fire.

### SUMMARY

One implementation of the present disclosure is a modular fire suppression unit, according to some embodiments. In some embodiments, the modular fire suppression unit includes a housing, an off-gas detector, a fire suppression apparatus, and a controller. In some embodiments, the off-gas detector is provided within the housing and is configured to obtain air samples and detect a presence of off-gas in each air sample. In some embodiments, the fire suppression apparatus is provided within the housing and configured to provide a fire suppression agent to a space. In some embodiments, the controller is provided within the housing and is configured to receive signals from the off-gas detector indicating whether off-gas is detected in each of the air samples. In some embodiments, the controller is also configured to activate the fire suppression apparatus to provide the fire suppression agent to the space in response to detecting off-gas in one or more of the air samples. In some embodiments, the modular fire suppression unit is configured to be coupled to a sidewall of an enclosure.

In some embodiments, the fire suppression apparatus, the controller, and the off-gas detector are positioned within the housing.

In some embodiments, the modular fire suppression unit includes multiple of the off-gas detectors. In some embodiments, each of the multiple the off-gas detectors is configured to detect the presence of off-gas in a corresponding one of one or more battery racks in the enclosure.

In some embodiments, the off-gas detector is configured to draw an air sample from each of the multiple battery racks that are positioned within the enclosure serially. In some embodiments, the off-gas detector is configured to fluidly couple with the plurality of battery racks through a piping system. In some embodiments, the piping system includes one or more tubular members that each fluidly couple the off-gas detector with a corresponding one of the plurality of battery racks. In some embodiments, the controller is configured to operate one or more suction pumps to draw the air sample from each of the plurality of battery racks through the piping system to draw a first air sample from a first one of the plurality of battery racks at a first time, and a second air sample from a second one of the plurality of battery racks at a second time.

In some embodiments, the off-gas detector is configured to detect presence or concentration of any of a lithium-ion battery off-gas, carbon dioxide, methane, ethane, hydrogen, oxygen, nitrogen oxides, volatile organic compounds, ash, soot, hydrogen sulfide, sulfur oxides, ammonia, chlorine, propane, ozone, ethanol, hydrocarbons, hydrogen cyanide, combustible cases, flammable gases, toxic gases, corrosive gases, oxidizing gases, or an electrolyte vapor in the air sample.

In some embodiments, the controller is configured to receive signals from the off-gas detector indicating a concentration of off-gas in the air sample, compare the concentration of off-gas to a threshold value, and activate the fire suppression apparatus in response to the concentration of off-gas in the air sample exceeding the threshold value.

Another implementation of the present disclosure is a fire suppression system, according to some embodiments. In some embodiments, the fire suppression system includes an enclosure, one or more battery racks, and a modular fire suppression assembly. In some embodiments, the enclosure includes sidewalls and an internal volume defined within the sidewalls. In some embodiments, the one or more battery racks are positioned within the enclosure. In some embodiments, the modular fire suppression assembly includes an off-gas detector, a fire suppression apparatus, and a controller. In some embodiments, the off-gas detector is configured to obtain air samples from each of the one or more battery racks and detect a presence of off-gas in each of the one or more battery racks. In some embodiments, the fire suppression apparatus is configured to provide a fire suppression agent to the internal volume of the enclosure. In some embodiments, the controller is configured to receive signals from the off-gas detector indicating whether off-gas is detected in each of the one or more battery racks and activate the fire suppression apparatus to provide the fire suppression agent to the internal volume of the enclosure.

In some embodiments, the enclosure is any of a shipping container or a storage container and includes a vent configured to selectively fluidly couple the internal volume of the enclosure with an external environment.

In some embodiments, the fire suppression system further includes multiple of the off-gas detectors. In some embodiments, each of the multiple off-gas detectors is configured to detect the presence of off-gas in a corresponding one of the one or more battery racks and the off-gas detector is configured to draw an air sample from each of the battery racks serially. In some embodiments, the fire suppression system includes a piping system having one or more tubular members that each fluidly couple the off-gas detector with a corresponding one of the one or more battery racks. In some embodiments, the controller is configured to operate one or more suction pumps to draw a first air sample from a first one of the one or more battery racks at a first time, and a second air sample from a second one of the one or more battery racks at a second time.

In some embodiments, the off-gas detector is configured to detect presence or concentration of any of a lithium-ion battery off-gas, carbon dioxide, methane, ethane, hydrogen, oxygen, nitrogen oxides, volatile organic compounds, ash, soot, hydrogen sulfide, sulfur oxides, ammonia, chlorine, propane, ozone, ethanol, hydrocarbons, hydrogen cyanide, combustible cases, flammable gases, toxic gases, corrosive gases, oxidizing gases, or an electrolyte vapor in the air samples.

In some embodiments, the controller is configured to receive signals from the off-gas detector indicating a concentration of off-gas in one or more of the battery racks. In some embodiments, the controller is configured to compare the concentration of off-gas to a threshold value and activate the fire suppression apparatus in response to the concentration of off-gas in the battery racks exceeding the threshold value.

In some embodiments, the controller is configured to shut-off the one or more battery racks in response to detecting off-gas in the one or more battery racks.

In some embodiments, the controller is configured to alert emergency personnel in response to detecting off-gas in one or more of the battery racks.

In some embodiments, the controller is configured to operate a visual alert device or an aural alert device in response to detecting off-gas in one or more of the battery racks.

In some embodiments, the fire suppression system further includes an HVAC system. In some embodiments, the off-gas detector is positioned in an air stream of the HVAC system to reduce a number of off-gas detectors.

In some embodiments, the controller is configured to operate the HVAC system to open external vents to circulate air into the enclosure to prevent a buildup of off-gases from the one or more battery racks.

In some embodiments, the controller is configured to operate the HVAC system to reduce a pressure within the enclosure when the fire suppression apparatus is activated.

Another implementation of the present disclosure is a fire suppression system including an enclosure, one or more batter racks positioned within the enclosure, and a modular fire suppression assembly. In some embodiments, the enclosure include sidewalls and an internal volume defined within the sidewalls. In some embodiments, the modular fire suppression assembly includes sidewalls and an internal volume. In some embodiments, the modular fire suppression assembly is coupled with sidewalls of the enclosure and includes an off-gas detector, a fire suppression apparatus, and a controller. In some embodiments, the off-gas detector is configured to obtain air samples from each of the one or more battery racks and detect a presence of off-gas in each of the one or more battery racks. In some embodiments, the fire suppression apparatus is configured to provide a fire suppression agent to the internal volume of the enclosure and the internal volume of the modular fire suppression assembly. In some embodiments, the controller is configured to receive signals from the off-gas detector indicating whether off-gas is detected in each of the one or more battery racks and activate the fire suppression apparatus to provide the fire suppression agent to the internal volume of the enclosure.

In some embodiments, the off-gas detector is configured to detect a presence of off-gas in any of the one or more battery racks within five seconds of the off-gas being present.

In some embodiments, the fire suppression system further includes an ambient off-gas detector configured to monitor a presence or concentration of off-gas outside of the one or more battery racks. In some embodiments, the controller is configured to receive signals from the ambient off-gas detector and determine a difference between an ambient concentration of off-gas outside of the one or more battery racks and a concentration of off-gas within the one or more battery racks.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying FIGURES, wherein like reference numerals refer to like elements, in which:

FIG. 1 is a block diagram of a fire suppression system usable with a battery rack, according to some embodiments.

FIG. 2 is a block diagram of a fire suppression system usable with multiple battery racks, according to some embodiments.

FIG. 3 is a block diagram of a fire suppression system usable with a battery rack, according to some embodiments.

FIG. 4 is a perspective view of a container or enclosure equipped with a fire suppression system, according to some embodiments.

FIG. 5 is another perspective view of the container or enclosure and suppression system of FIG. 4, according to some embodiments.

FIG. 6 is a block diagram of a controller usable with the fire suppression systems of FIGS. 1-3 or the battery fire suppression system of FIGS. 4-5, according to some embodiments.

FIG. 7 is a flow diagram of a process for suppressing fires, according to some embodiments.

FIG. 8 is a schematic diagram of a fire suppression system, according to some embodiments.

### DETAILED DESCRIPTION

Before turning to the FIGURES, which illustrate the exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

### OVERVIEW

Referring generally to the FIGURES, a fire suppression system is shown, according to some embodiments. The fire suppression system is, in some embodiments, usable with batteries and/or battery racks. The batteries may be stored within a container (e.g., a shipping container, a storage container, an enclosure, etc.). The fire suppression system may be provided as a modular fire suppression assembly that can be coupled with the container such that an internal volume of the modular fire suppression assembly is fluidly coupled with an internal volume of the container. The modular fire suppression system can include an off-gas detector configured to monitor and detect the presence of off-gas in the container (e.g., emitted by the batteries as the batteries begin to fail). In some embodiments, one or more off-gas detectors are positioned at and associated with each battery. In other embodiments, a single off-gas detector is positioned within the internal volume of the modular fire suppression assembly or within the internal volume of the container. The fire suppression system can include various plumbing and suction pumps configured to draw air samples from each battery (if a single off-gas detector is used that is not positioned locally at the batteries). The modular fire suppression assembly can include a controller that receives signals generated by the off-gas detector to indicate a concentration and/or presence of off-gas in the container.

The controller (e.g., a fire panel) can operate the suction pumps to modulate the pressure through various conduits to draw an air sample from each battery. The controller can use the off-gas detector to identify the concentration or levels of off-gas in the container. If the concentration or level of off-gas in the container exceeds a threshold value (e.g., a predetermined threshold value), this may indicate that a fire is likely to occur in the near future. The controller can activate a fire suppression apparatus to provide a fire suppression agent to the internal volume of the container and/or the internal volume of the modular fire suppression assembly to prevent the fire from occurring (e.g., to prevent or suppress combustion). Advantageously, the fire suppression system can preemptively detect and respond to conditions at the batteries to prevent a fire from occurring. Advantageously, the fire suppression system can provide single battery cell failure detection before thermal runaway occurs. When thermal runaway occurs at a single battery cell, thermal propagation may occur thereby causing a domino effect into adjacent cells and causing an increase in temperature in the adjacent cells. Off-gas detection can occur within five seconds of off-gas being generated at the battery cell. The systems and methods described herein for off-gas detection can be used in addition to or in place of uninterrupted power supply (UPS) technologies. The systems and methods described herein can be applied for wind farms and corresponding commercial equipment thereof, solar farms and commercial equipment thereof, data center or battery rooms, battery manufacturing applications, etc.

### Battery Monitoring and Fire Suppression System

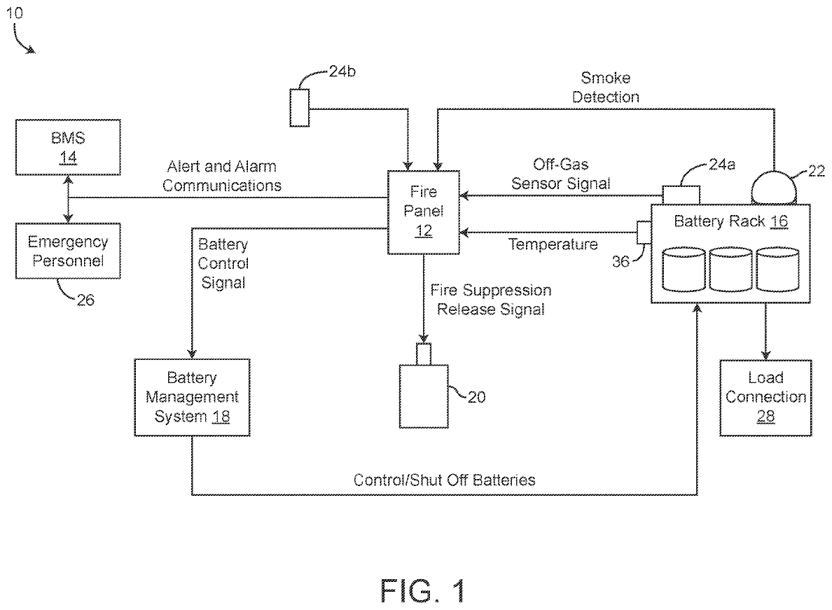

Referring particularly to FIGS. 1-3, various embodiments of a fire suppression system 10 are shown. In some embodiments, fire suppression system 10 is configured to monitor smoke and/or gases within an enclosure emitted by one or more batteries, lithium-ion batteries, battery racks, lithium-ion battery racks, etc., to monitor the batteries. Fire suppression system 10 can monitor the enclosure and/or batteries to determine if a fire is likely to occur in the near future. In some embodiments, fire suppression system 10 is configured to activate various fire suppression apparatuses (e.g., an inert gas system) to suppress and prevent the occurrence of fire within the enclosure (e.g., at the batteries or nearby the batteries). Advantageously, fire suppression system 10 may prevent thermal runaway at the batteries and prevent the lithium ion batteries from combusting.

Preventing thermal runaway of the lithium ion batteries is advantageous since after lithium-ion batteries combust, they can be difficult to extinguish. Therefore, monitoring the gas emitted by the lithium-ion batteries and activating the fire suppression system may prevent or suppress the start and growth of the fire.

Referring particularly to FIG. 1, fire suppression system 10 includes a fire panel, a main controller, etc., shown as fire panel 12 and a battery, a set of batteries, a battery rack, a lithium-ion battery, an energy storage system (ESS), etc., shown as battery rack 16. Fire suppression system 10 also includes an off-gas detector, a sensor, etc., shown as air sampling detector 24a, according to some embodiments. In some embodiments, fire suppression system 10 includes air sampling detector 24a and an air sampling detector 24b. In some embodiments, air sampling detector 24a is configured to monitor or sense the presence of off-gas emitted by battery cells (e.g., lithium-ion battery cells of battery rack 16). In some embodiments, air sampling detector 24b is functionally the same as air sampling detector 24a such that any of the functionality of air sampling detector 24a may be said of air sampling detector 24b. In some embodiments, air sampling detector 24b is configured to perform or facilitate off-gas detection of ambient air (e.g., at a location a distance from battery rack 16) to provide a reference or a baseline off-gas concentration for fire panel 12. In some embodiments, air sampling detector 24b is integrated in a same housing or a same unit with air sampling detector 24a. In some embodiments, the battery cells of battery rack 16 are a gas source that emit the off-gas. In some embodiments, air sampling detector 24a is a gas analyzer, a gas sensor, etc., configured to detect the presence of off-gas emitted by the battery cells of battery rack 16. Air sampling detector 24a can be configured to draw samples of air/gas from within battery rack 16 and may analyze the samples to detect the presence or concentration of off-gas in the sample. In some embodiments, air sampling detector 24a is configured to detect the presence or concentration of any of a lithium-ion battery off-gas, carbon dioxide, carbon monoxide, methane, ethane, hydrogen, oxygen, nitrogen oxides, volatile organic compounds, ash, soot, hydrogen sulfide, sulfur oxides, ammonia, chlorine, propane, ozone, ethanol, hydrocarbons, hydrogen cyanide, combustible gases, flammable gases, toxic gases, corrosive gases, oxidizing gases, an electrolyte vapor, etc.

In some embodiments, air sampling detector 24a is configured to monitor and identify a presence of the off-gas emitted by battery cells of battery rack 16. In other embodiments, air sampling detector 24a is configured to measure a concentration of the off-gas emitted by battery cells of battery rack 16. For example, air sampling detector 24a can measure the off-gas in parts per million. In some embodiments, air sampling detector 24a is configured to independently measure a concentration and/or a presence of each of any of the various off-gases described in greater detail above. For example, air sampling detector 24a can measure the concentration of each of lithium-ion battery off-gases, carbon dioxide, volatile organic compounds, etc., independently. In some embodiments, air sampling detector 24a is mounted (e.g., fixedly coupled, fastened, etc.) to battery rack 16. In some embodiments, at least one air sampling detector 24a is positioned at each battery rack 16 and is configured to detect off-gas in battery rack 16. In some embodiments, if air sampling detector 24a is positioned at battery rack 16 (e.g., fixedly coupled with, mounted to, positioned within, etc.), air sampling detector 24a may rely on internal airflow in battery rack 16. Battery rack 16 can include a cooling fan configured to drive airflow over the battery cells of battery rack 16 to force convective heat transfer (e.g., to cool the battery cells in battery rack 16).

Air sampling detector 24a can provide fire panel 12 with the identified presence of off-gas and/or the concentration of off-gas. In some embodiments, air sampling detector 24a provides an off-gas sensor signal to fire panel 12. In some embodiments, fire panel 12 uses the off-gas sensor signal to determine if a fire suppression apparatus 20 should be activated. In some embodiments, fire suppression apparatus 20 includes a tank, a container, a capsule, a cartridge, a pressure vessel, etc., that is configured to store and discharge a fire suppression agent. In some embodiments, fire suppression apparatus 20 includes any piping, plumbing, conduits, tubular members, discharge devices, nozzles, sprayers, outlets, etc., configured to fluidly couple with the tank and deliver or provide the fire suppression agent to battery rack 16 and/or to an enclosure within which battery rack 16 is positioned. In some embodiments, fire suppression apparatus 20 includes a cartridge, a discharge pressure vessel, a container, a capsule, etc., configured to fluidly couple with the tank that stores the fire suppression agent. In some embodiments, the cartridge contains a pressurized discharge gas that is configured to pressurize the fire suppression agent and drive the fire suppression agent into or toward battery rack 16. In some embodiments, the fire suppression agent is an inert gas, an ideal gas, etc., configured to flood and substantially fill battery rack 16. In some embodiments, the fire suppression agent is a foam fire suppression agent that can be sprayed onto the battery cells of battery rack 16. In some embodiments, an inner volume of battery rack 16 is flooded with the fire suppression agent. In some embodiments, an entire volume of an enclosure within which battery rack 16 is positioned is flooded with the fire suppression agent.

Fire panel 12 can receive the off-gas sensor signals from air sampling detector 24a and provide fire suppression activation signals to an activator of fire suppression apparatus 20. In some embodiments, fire panel 12 activates fire suppression apparatus 20 by puncturing a rupture disk or otherwise fluidly coupling the cartridge that contains the discharge gas with an internal volume of the vessel that contains the fire suppression agent. In some embodiments, fire panel 12 includes a processing circuit, a processor, and/or memory configured to execute one or more processes as described herein. For example, fire panel 12 can receive the off-gas sensor signals from air sampling detector 24a, compare the concentration of the off-gasses in battery rack 16 to corresponding threshold values, and perform one or more operations in response to one or more of the concentrations of the off-gases exceeding the corresponding threshold values.

Referring still to FIG. 1, fire suppression system 10 can include a battery management system 18. In some embodiments, battery management system 18 is configured to operate the battery cells of battery rack 16. For example, battery management system 18 can be configured to activate or de-activate the battery cells of battery rack 16 so that a user can draw power from the battery cells of battery rack 16 (e.g., at load connection 28). In some embodiments, battery management system 18 is configured to shut down power from battery cells of battery rack 16 in response to receiving control signals from fire panel 12. For example, battery management system 18 can receive a command from fire panel 12 to shut down battery rack 16 in response to the off-gas in battery rack 16 exceeding the corresponding threshold value. Fire panel 12 can generate battery control signals based on the off-gas sensor signals and provide the battery control signals to battery management system 18. In some embodiments, battery management system 18 receives the battery control signals from fire panel 12 and controls or shuts off battery rack 16 using the battery control signals. The battery control signals generated by fire panel 12 and the operations performed by battery management system 18 can include changing the position of a switch, adjusting output voltage, adjusting output current, etc., of battery rack 16.

In some embodiments, fire suppression system 10 also includes a smoke detector 22. In some embodiments, smoke detector 22 is a sensor configured to measure soot, ash, particulate matter, smoke, airborne particulate, etc. Smoke detector 22 can draw a sample of air from battery rack 16 and detect the presence or concentration of particulate (e.g., airborne particles) matter in the sample of air. In some embodiments, smoke detector 22 provides fire panel 12 with smoke detection signals. In some embodiments, fire panel 12 can use the smoke detection signals to activate fire suppression apparatus 20. In some embodiments, fire panel 12 uses the smoke detection to generate the battery control signals and provides the battery control signals to battery management system 18. Smoke detector 22 may be positioned at or near battery rack 16, within an enclosure that battery rack 16 is contained within, etc.

Referring still to FIG. 1, fire panel 12 can provide alert and/or alarm communications/signals to a building management system (BMS) 14 and/or emergency personnel 26. In some embodiments, the alert/alarm signals are generated by fire panel 12 based on one or more of the off-gas sensor signals (e.g., based on the presence of off-gas in battery rack 16, based on the concentration of off-gas in battery rack 16, etc.) received from air sampling detector 24a, the smoke detection signals (e.g., based on the presence of airborne particulate matter, based on the concentration of airborne particulate matter, etc.) received from smoke detector 22, etc. In some embodiments, fire suppression system 10 also includes one or more temperature sensors 36 that are configured to sense a temperature within or at battery rack 16. In some embodiments, temperature sensor 36 is configured to measure or sense a temperature in a container that battery rack 16 is positioned within. In some embodiments, temperature sensor 36 is any of an optical temperature sensor, a thermocouple, a thermally responsive member, a negative temperature coefficient thermistor, a resistance temperature detector, a semi-conductor based temperature sensor, etc. In some embodiments, temperature sensor 36 provides the measured/sensed temperature of battery rack 16, temperature within battery rack 16, temperature at any or all of the battery cells of battery rack 16, temperature within a container that battery rack 16 is stored within, etc., and provides the temperature to fire panel 12. Fire panel 12 can use the measured temperature to generate the alert/alarm signals, the battery control signals, and/or the fire suppression release signals.

Fire panel 12 can also notify emergency personnel 26 in response to detecting that a fire has occurred at battery rack 16, or in response to determining that a fire is likely to occur in the near-future at battery rack 16. For example, fire panel 12 may use any of the off-gas sensor signals, the smoke detection signals, and/or the temperature at battery rack 16 to preemptively detect fire at battery rack 16 (e.g., to detect that a fire may occur in the near-future, before the fire occurs) and respond preemptively to prevent the fire. In some embodiments, fire panel 12 preemptively detects a fire at battery rack 16 and responds to prevent thermal runaway at battery rack 16, thereby preventing a fire from occurring at battery rack 16.

In some embodiments, fire panel 12 provides the alert to emergency personnel as a text message (e.g., an SMS message), an email, a remote notification, an instant message, an automated phonecall, a visual alert, an aural alert, etc., to emergency personnel 26 (e.g., a customer, a technician, a fire department, a building manager, a shipping manager, a remote system/network, etc.). Fire panel 12 can provide the alert to emergency personnel 26 in response to detecting that a fire has occurred at battery rack 16 (e.g., based on temperature received from temperature sensor 36 and/or based on smoke detection signals received from smoke detector 22) or in response to determining that a fire is likely to occur at battery rack 16 in the near future (e.g., preemptively, based on off-gas sensor signals received from air sampling detector 24a).

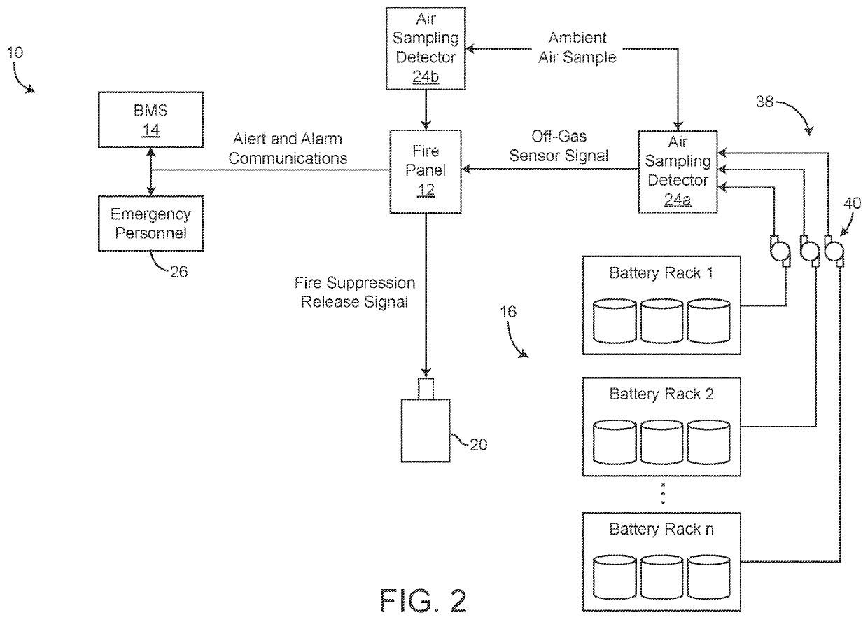

Referring particularly to FIG. 2, fire suppression system 10 can include multiple battery racks 16. For example, fire suppression system 10 can include n battery racks 16. In some embodiments, fire suppression system 10 includes multiple air sampling detectors 24. For example, fire suppression system 10 can include an air sampling detector 24a for each battery rack 16. In some embodiments, fire suppression system 10 includes a single air sampling detector 24a configured to measure off-gas in each of battery racks 16. In some embodiments, air sampling detector 24a is configured to draw air samples serially from battery racks 16. For example, air sampling detector 24a can be connected or fluidly coupled with battery racks 16 through a piping system 38 that includes pipes, conduits, hoses, tubular members, etc. Piping system 38 can include suction pumps 40 configured to draw air through piping system 38 and provide the air samples to air sampling detector 24a. In some embodiments, air sampling detector 24a, fire panel 12, and/or off-gas control panel 34 operate suction pumps 40 to draw air samples from battery racks 16 to air sampling detector 24a.

Air sampling detector 24a can draw an air sample from each of battery racks 16 serially. For example, air sampling detector 24a may first draw an air sample from the first battery rack 16 and detect the presence and/or concentration of off-gas in the first battery rack 16. Air sampling detector 24a then provides the off-gas sensor signal to fire panel 12 for further analysis, processing, etc., to determine if a fire has occurred or is likely to occur in the near future at the first battery rack 16. Air sampling detector 24a may then proceed to drawing an air sample from the second battery rack 16, a third battery rack 16, etc. In this way, a single air sampling detector 24a can be used to monitor and detect the presence and/or concentration of off-gas in battery racks 16. This facilitates a more efficient and cost-effective fire suppression system 10. In some embodiments, the volume of air sample drawn from battery racks 16 is substantially uniform. For example, air sampling detector 24a may draw a volume of air Vₛₐₘₚₗₑ from battery racks 16 each time. In some embodiments, air sampling detector 24a uses the known volume of the air sample drawn from battery racks 16 to determine the concentration of off-gas in battery racks 16.

In some embodiments, air sampling detector 24a draws air samples from multiple of battery racks 16. For example, if ten battery racks 16 are used, air sampling detector 24a may draw air samples from the first five battery racks 16 and detect if off-gas is present in the air samples. Air sampling detector 24a may also concurrently draw air samples from the next five battery racks 16 and detect if off-gas is present in the next five battery racks 16. In response to detecting the presence of off-gas in the first five or the next five battery racks 16, air sampling detector 24a may then proceed to draw air samples from subsets of the first five and/or the next five battery racks 16. In this way, air sampling detector 24a can start from sets of battery racks 16 that include multiple battery racks 16 and progressively draw air samples from smaller sets of battery racks 16 to determine in which of battery racks 16 off-gas is present.

Advantageously, fire suppression system 10 as shown in FIG. 2 uses a single air sampling detector 24a which draws air samples from battery racks 16 (e.g., by operating suction pumps 40). By serially modulating the suction through the pipes that fluidly couple air sampling detector 24a with battery racks 16, a single air sampling detector 24a can be used, thereby decreasing costs associated with purchasing, manufacturing, and maintaining fire suppression system 10. Additionally, using suction pumps 40 removes the requirement for air sampling detector 24a to rely on airflow within battery racks 16. Specifically, suction pumps 40 can draw air samples from battery racks 16, even if there is no air flow present in battery racks 16 or if there is not a sufficient airflow within battery racks 16. Air sampling detector 24a can be positioned remotely or a distance from battery racks 16, thereby advantageously facilitating accessibility of air sampling detector 24a for maintenance, inspection, and installation.

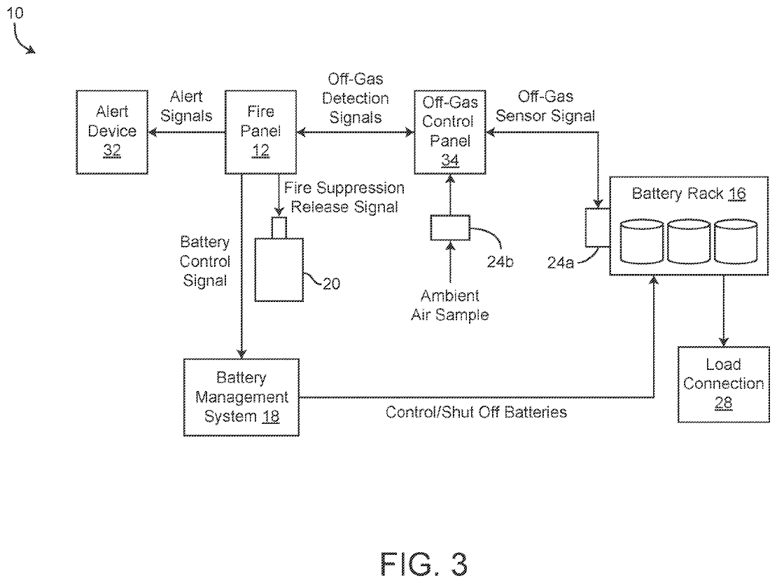

Referring now to FIG. 3, fire suppression system 10 can include an off-gas control panel 34. In some embodiments, off-gas control panel 34 is configured to receive the off-gas sensor signals from air sampling detector 24a and provide fire panel 12 with off-gas detection signals. Off-gas control panel 34 can be a controller including a processing circuit, a processor, and memory. In some embodiments, off-gas control panel 34 is configured to analyze the signals received from air sampling detector 24a and identify if off-gas is present in battery rack 16 or to determine the concentration of off-gas present in battery rack 16. Off-gas control panel 34 can provide fire panel 12 with the off-gas detection signals. In some embodiments, off-gas control panel 34 is a local controller that is positioned at battery rack 16. Off-gas control panel 34 can be configured to perform low-level analysis of the off-gas sensor signals to determine if off-gas is present in battery rack 16, whereas fire panel 12 can be configured to perform higher-level analysis (e.g., to determine if a fire is likely to occur in the near future, to activate fire suppression apparatus 20, to perform an appropriate response, etc.).

Referring still to FIG. 3, fire suppression system 10 can include an alert device 32. In some embodiments, alert device 32 is or includes any of a visual alert device (e.g., a light emitting device, a light emitting diode, etc.), an aural alert device (e.g., a speaker, a sound-producing device, etc.), or any combination thereof. In some embodiments, fire panel 12 is configured to provide alert signals to alert device 32 in response to detecting a fire or in response to determining that a fire is likely to occur in the near future at any of battery racks 16 (e.g., in response to detecting the presence of off-gas in any of battery racks 16, in response to detecting that the concentration of off-gas in any of battery racks 16 exceeds a corresponding threshold value, etc.). In some embodiments, fire panel 12 operates alert device 32 to provide a visual and/or aural alert or indication to a user or technician that a fire has occurred or is likely to occur. Alert device 32 can be configured to produce a siren noise, emit a colored light, etc., in response to receiving the alert signals from fire panel 12 to alert the user that a fire has occurred or is likely to occur at battery rack 16. In some embodiments, fire panel 12 is configured to operate alert device 32 in response to determining that fire suppression apparatus 20 should be activated. In this way, alert device 32 can be used to notify the user that fire suppression apparatus 20 has been activated.

It should be understood that while FIGS. 1-3 show various embodiments of fire suppression system 10, any of the devices, components, functionality, etc., of fire suppression system 10 as shown in FIGS. 1-3 can be combined. For example, smoke detector 22 of the embodiment of fire suppression system 10 shown in FIG. 1 may be integrated into or included in the embodiment of fire suppression system 10 as shown in FIG. 2 or 3 and described in greater detail above.

### Battery Container System

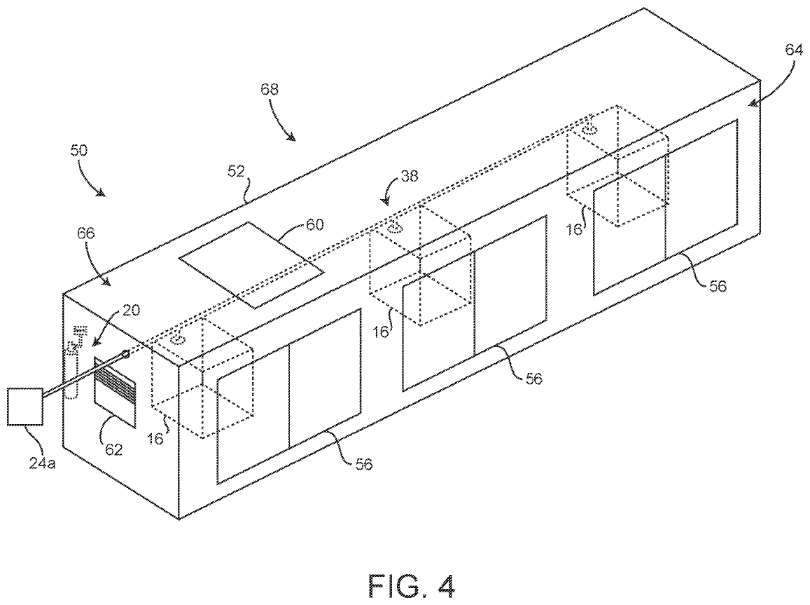

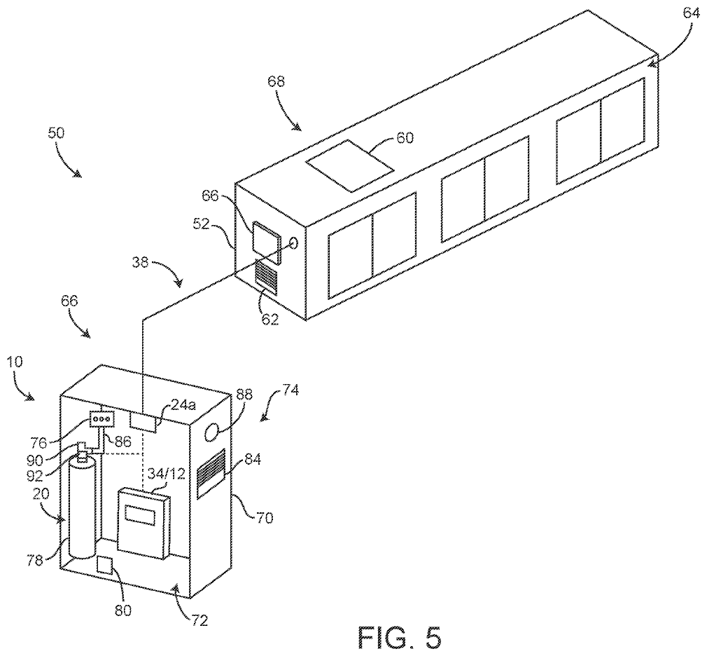

Referring now to FIGS. 4 and 5, a battery rack system 50 includes a fire suppression system 66 that is usable with a shipping container, a storage container, an enclosure, a battery compartment, a compartment, a room, a space, etc., shown as storage container 68. In some embodiments, battery container system 50 and fire suppression system 66 are similar to fire suppression system 10 and includes any of the features, functionality, components, devices, configurations, etc., of fire suppression system 10. In some embodiments, battery container system 50 includes fire suppression system 10. For example, battery container system 50 can include various components of fire suppression system 10 stored within a fire suppression unit, a modular unit, a removable fire suppression attachment, etc., shown as modular fire suppression attachment 74 as described in greater detail below.

Storage container 68 includes sidewalls, walls, panels, planar members, etc., shown as sidewalls 52. In some embodiments, storage container 68 is a generally rectangular container with six sidewalls 52. In other embodiments, storage container 68 is a room, a storage space, a closet, a compartment, etc., with sidewalls 52. Sidewalls 52 define an internal volume, an inner volume, a space, a storage space, an area, etc., shown as internal volume 65. Storage container 68 can be any structure or compartment that includes sidewalls and an inner volume for storing or transporting battery racks 16. Battery racks 16 are positioned in internal volume 65 within sidewalls 52. In some embodiments, battery racks 16 are positioned adjacent to each other. In some embodiments, battery racks 16 are spaced a distance apart throughout internal volume 65 of storage container 68. Battery racks 16 can fill substantially an entirety of internal volume 65 and may be accessible through doors, openings, apertures, windows, shutters, etc., shown as doors 56. In some embodiments, doors 56 are configured to selectably transition between a closed position and an open position to facilitate access of battery racks 16. In some embodiments, doors 56 are positioned along one side of shipping container 68. In some embodiments, doors 56 are positioned along two or more sides (e.g., sidewalls 52) of shipping container 68. In some embodiments, each battery rack 16 is associated with a corresponding door 56 to facilitate accessing each battery rack 16. Doors 56 can be independently selectably transitioned between the open position and the closed position. Doors 56 can be transitioned between the open and the closed position manually (e.g., by a technician, an operator, a user, etc.) or automatically (e.g., with various linkages, primary movers, electric motors, pistons, hydraulic cylinders, electric linear actuators, hydraulic linear actuators, hydraulic motors, internal combustion engines, etc.).

Storage container 68 (or more generally, battery container system 50) can include a heating, ventilation and air conditioning (HVAC) system 60. In some embodiments, HVAC system 60 is operated by BMS 14. In some embodiments, HVAC system 60 is controlled by fire panel 12. In other embodiments, HVAC system 60 is controlled by another controller (e.g., a building controller). HVAC system 60 can be any heating, ventilation, or air conditioning system that is configured to transfer heat into container 68, remove heat from storage container 68, force airflow through storage container 68 to ventilate storage container 68, circulate air through storage container 68, purify air circulating through storage container 68, etc. For example, HVAC system 60 can be a packaged air conditioning unit configured to provide ventilation and cooling to battery racks 16. In some embodiments, HVAC system 60 forces airflow through storage container 68 to facilitate forced convective cooling of battery racks 16. For example, HVAC system 60 can include a fan configured to drive outdoor air through storage container 68. HVAC system 60 may be operated by fire panel 12 to open external vents to facilitate or force airflow through storage container 68. HVAC system 60 can be operated by fire panel 12 concurrently with activation of fire suppression apparatus 20 to reduce a pressure within storage container 68. In some embodiments, air sampling detector 24a is positioned along an airflow path of HVAC system 60 to reduce a required number of air sampling detectors 24.

Referring still to FIG. 4, storage container 68 includes a vent 62, according to some embodiments. Vent 62 can include louvres and may be selectably transitionable between an open configuration and a closed configuration. In some embodiments, multiple vents 62 are positioned about storage container 68 to facilitate airflow through internal volume 64 of storage container 68. In some embodiments, air flows into internal volume 64 of container 68 through vent 62. In some embodiments, air flow out of internal volume 64 of container 68 through vent 62. Vents 62 can be positioned at opposite ends or on opposite sides of container 68 to facilitate airflow through storage container 68. In some embodiments, vents 62 are driven to transition between the open configuration and the closed configuration by forced airflow through storage container 68.

In some embodiments, battery container system 50 includes piping system 38. Piping system 38 can extend through storage container 68 and can include various tubular members, hoses, conduits, pipes, etc., that are fluidly coupled with an internal volume of each battery rack 16. In some embodiments, battery container system 50 also includes a suction pump configured to draw air samples from each battery rack 16 independently. Piping system 38 can be fluidly coupled with air sampling detector 24a so that the air samples are provided to air sampling detector 24a. Air sampling detector 24a can operate suction pumps 40 to draw the air sample from each battery rack 16.

Referring particularly to FIG. 4, battery container system 50 can include fire suppression apparatus 20. In some embodiments, fire suppression apparatus 20 is a component of fire suppression system 66. Fire suppression apparatus 20 can be positioned within internal volume 64 of storage container 68. For example, fire suppression apparatus 20 can mounted or fixedly coupled with one of sidewalls 52 within storage container 68. In some embodiments, fire suppression apparatus 20 is configured to deliver or provide a fire suppression agent (e.g., an inert gas, a gaseous mixture that suppresses combustion, etc.) into internal volume 64. In some embodiments, fire suppression apparatus 20 is activated to provide the fire suppression agent to internal volume 64 by fire panel 12. In some embodiments, multiple fire suppression apparatuses 20 are positioned within internal volume 64 of storage container 68. The multiple fire suppression apparatuses 20 can be activated concurrently by fire panel 12 or may be activated individually/independently from each other by fire panel 12 to target a specific battery rack 16. In some embodiments, each battery rack 16 is associated with a corresponding fire suppression apparatus 20 (e.g., a fire suppression apparatus 20 that is positioned nearby) that is configured to provide fire suppression agent to the associated battery rack 16 to prevent or suppress combustion at or around the associated battery rack 16.

When fire suppression apparatus 20 provides the fire suppression agent to internal volume 64 of storage container 68, vents 62 may be actively transitioned into the open configuration (e.g., by an electric motor, an electric linear actuator, a primary mover, an engine, a hydraulic cylinder, a pneumatic cylinder, a solenoid, etc.) so that oxygen is vented out of storage container 68. Once the fire suppression agent floods substantially the entirety of internal volume 64 of storage container 68 (or once the concentration of oxygen within storage container 68 is at an acceptably low level), vents 62 can be transitioned into the closed position/configuration to maintain the fire suppression agent within storage container 68 to facilitate suppressing of combustion within storage container 68.

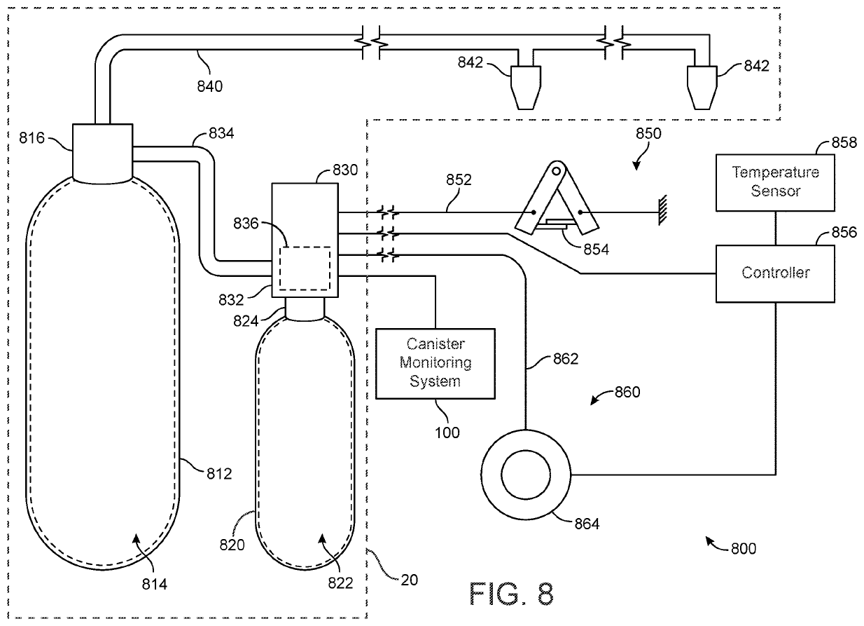

Referring still to FIG. 4, fire suppression system 66 can be positioned at least partially within storage container 68. In some embodiments, fire suppression system 66 is the same as or similar to fire suppression system 800 as described in greater detail below. For example fire suppression system 66 can include pipe 840, nozzles 842, fire suppressant tank 812, cartridge 820, actuator 830, controller 856, etc. (described in greater detail below with reference to FIG. 8). In some embodiments, fire suppression system 66 includes various nozzles configured to provide fire suppression agent onto battery racks 16 and/or throughout internal volume 64. In some embodiments, fire suppression system 66, or the various fire suppression components thereof, is/are activated by fire panel 12. In some embodiments, fire suppression system 66 includes fire panel 12. In some embodiments, when fire suppression system 66 is activated, fire suppression system 66 distributes or provides fire suppression agent onto battery rack 16 and/or through internal volume 64. In some embodiments, fire suppression system 66 is used in addition to or in place of fire suppression apparatuses 20. It should be understood that references to “activating” or “operating” fire suppression apparatus 20 can also refer to “activating” or “operating” fire suppression system 66, fire suppression apparatus 20, or both fire suppression apparatus 20 and fire suppression system 66.

Referring particularly to FIG. 5, fire suppression system 66 can be provided as or configured as a modular fire suppression attachment 74. Modular fire suppression attachment 74 can be a bolt-on or removably coupled system that includes various components of fire suppression system 10. In some embodiments, modular fire suppression attachment 74 sealingly and fixedly couples with storage container 68. In some embodiments, modular fire suppression attachment 74 is a container (e.g., a box-shaped container) having an open side or openings such that electrical wires and/or plumbing components (e.g., conduits or tubular members of piping system 38) can connect with the various components and devices of modular fire suppression attachment 74. In some embodiments, modular fire suppression attachment 74 is attached or fixedly coupled with sidewall 52 of storage container 68 such that the open side faces inwards and directly fluidly couples with the internal volume 64 of storage container 68. Modular fire suppression attachment 74 can include a housing, sidewalls, panels, etc., shown as housing 70. Housing 70 defines an internal volume 72 of modular fire suppression attachment 74. The open side or opening of modular fire suppression attachment 74 can be configured to align with a corresponding opening or window of storage container 68 so that internal volume 72 of modular fire suppression attachment 74 and internal volume 64 of storage container 68 form a united internal volume.

Modular fire suppression attachment 74 can include a vent 84 that is configured to vent internal volume 72 with the environment outside of modular fire suppression attachment 74. In some embodiments, vent 84 includes louvres or is transitionable between an open state (e.g., a venting state) and a closed state (e.g., a sealed state). In some embodiments, internal volume 64 of storage container 68 and/or internal volume 72 of modular fire suppression attachment 74 are sealed internal volumes when vents 62 and/or vent 84 are transitioned into the closed state. In some embodiments, vent 84 of modular fire suppression attachment 74 is controllable. For example, vent 84 can be operated by an electric motor, an electric linear actuator, a pneumatic cylinder, a solenoid, a primary mover, etc., to transition between the open state and the closed state. In some embodiments, the primary mover is operated by fire panel 12.

Referring still to FIG. 5, modular fire suppression attachment 74 may include air sampling detector 24a. Air sampling detector 24a can receive air samples from each battery rack 16 through piping system 38 and detect the presence or concentration of off-gas in battery racks 16. In some embodiments, air sampling detector 24a is fixedly coupled with modular fire suppression attachment 74 inside of internal volume 72.

Referring still to FIG. 5, modular fire suppression attachment 74 includes a backup battery or power source, shown as battery 80, according to some embodiments. In some embodiments, fire suppression system 10 (or the components of fire suppression system 10 that are stored within modular fire suppression attachment 74) are powered by wall power (e.g., through a permanent power source). In some embodiments, if the electrical power provided to fire suppression system 10 fails, fire suppression system 10 draws power from battery 80 and uses battery 80 to operate. In this way, fire suppression system 10 or the components of fire suppression system 10 stored within modular fire suppression attachment 74 can still operate even in the case of a power outage.

Referring still to FIG. 5, modular fire suppression attachment 74 includes fire suppression apparatus 20, according to some embodiments. Fire suppression apparatus 20 can include a container, a fire suppression agent container, a pressure vessel, a cartridge, a capsule, a tank, etc., shown as agent container 78. Agent container 78 stores the fire suppression agent therewithin. For example, agent container 78 can store a gaseous fire suppression agent. In some embodiments, agent container 78 is the same as or similar to cartridge 820 and/or fire suppressant tank 812 as described in greater detail below with reference to FIG. 8.

Fire suppression apparatus 20 includes a neck 90, a pipe, a hose, a conduit, a tubular member, etc., shown as pipe 86, and a nozzle, a dispersion device, a suppression nozzle, a sprayer, etc., shown as suppression nozzle 76, according to some embodiments. In some embodiments, suppression nozzle 76 is fluidly coupled with an internal volume of agent container 78 through neck 90 and pipe 86. Fire suppression apparatus 20 can include an actuator 92 that is configured to selectively fluidly couple the internal volume of agent container 78 with pipe 86 and suppression nozzle 76. In some embodiments, actuator 92 is the same as or similar to activation mechanism 836 as described in greater detail below with reference to FIG. 8. Actuator 92 can be operated by fire panel 12 to selectively fluidly couple or de-couple the internal volume of agent container 78 with suppression nozzle 76. In some embodiments, the fire suppression agent within agent container 78 is pressurized such that when actuator 92 is transitioned into an open position (to fluidly couple the internal volume of agent container 78 with suppression nozzle 76), the fire suppression agent flows out of the internal volume of agent container 78, through neck 90 and pipe 86, and is discharged into internal volume 72 and internal volume 64 through suppression nozzle 76. The fire suppression agent may flood the entirety of internal volume 72 and internal volume 64. As the fire suppression agent floods internal volume 72 and internal volume 64, oxygen is evacuated through vent 84 and/or vent 62. Once the oxygen is suitably evacuated (e.g., once the oxygen level in internal volume 72 and/or internal volume 64 is sufficiently low for fire suppression), fire panel 12 can transition vent 84 and/or vent 62 out of the open position to the closed position to seal internal volume 72 and internal volume 64. Fire panel 12 can receive oxygen level data from an oxygen sensor and use the oxygen level data to determine when to transition vents 84 and/or 62 into the closed position. In some embodiments, fire panel 12 uses a time-based approach and maintains vents 84 and/or 62 in the open position for a predetermined time duration before closing vents 84 and/or 62.

Referring still to FIG. 5, modular fire suppression attachment 74 includes a connection, a hose connection, a connecting portion, an interfacing portion, an aperture, an opening, etc., shown as hose connection 88. In some embodiments, hose connection 88 includes an opening that extends through housing 70. Hose connection 88 can also include threads (e.g., pipe threads) configured to threadingly and sealingly couple with a hose, a tubular member, etc. For example, hose connection 88 may be configured to threadingly couple with a fire department hose or an emergency hose. In this way, if a fire occurs within internal volume 64 and/or internal volume 72, water (or a liquid, or a gas) can be flooded through the fire department hose or the emergency hose to fill internal volume 64 and internal volume 72, thereby extinguishing the fire.

It should be understood that the size of modular fire suppression attachment 74 can be scaled to accommodate various sizes of storage container 68. For example, larger storage container 68 may require additional fire suppression apparatuses 20, additional air sampling detectors 24, a larger modular fire suppression attachment 74, etc. All such configurations and modifications should be understood to be within the scope of the present disclosure.

It should be further understood that modular fire suppression attachment 74 can be used for any container, enclosure, space, room, vehicle, area, etc. For example, modular fire suppression attachment 74 can be configured to detect or predict fire in any room, space, enclosure, etc., regardless of whether or not batteries or battery racks are present or stored within the enclosure. In this way, modular fire suppression attachment 74 can be removably coupled onto a sidewall or ceiling of any enclosure, container, etc., and can be used to detect and suppress fire. For example, modular fire suppression attachment 74 can be used for storage spaces, data centers, vehicles, etc., and may still provide fire detection/suppression without requiring the presence of batteries or battery racks.

### Fire Panel

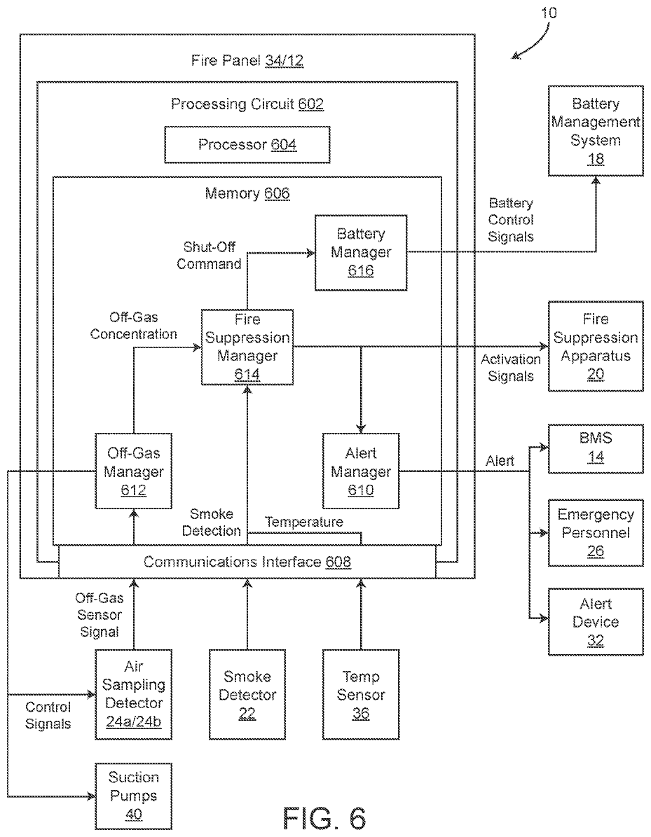

Referring now to FIG. 6, fire panel 12 is shown in greater detail, according to some embodiments. In some embodiments, fire panel 12 is configured to receive various sensor signals and determine if fire suppression apparatus 20 should be activated based on the received sensor signals. Any of the functionality of fire panel 12 as described herein with reference to FIG. 6 can be performed by off-gas control panel 34. For example, the functionality of fire panel 12 as described herein can be distributed across multiple devices (e.g., across fire panel 12 and off-gas control panel 34) or by a single controller.

Fire panel 12 can be a controller and is shown to include a processing circuit 602 including a processor 604 and memory 606. Processor 604 may be a general purpose or specific purpose processor, an application specific integrated circuit (ASIC), one or more field programmable gate arrays (FPGAs), a group of processing components, or other suitable processing components. Processor 604 is configured to execute computer code or instructions stored in memory 606 or received from other computer readable media (e.g., CDROM, network storage, a remote server, etc.).

Memory 606 may include one or more devices (e.g., memory units, memory devices, storage devices, etc.) for storing data and/or computer code for completing and/or facilitating the various processes described in the present disclosure. Memory 606 may include random access memory (RAM), read-only memory (ROM), hard drive storage, temporary storage, non-volatile memory, flash memory, optical memory, or any other suitable memory for storing software objects and/or computer instructions. Memory 606 may include database components, object code components, script components, or any other type of information structure for supporting the various activities and information structures described in the present disclosure. Memory 606 may be communicably connected to processor 604 via processing circuit 602 and may include computer code for executing (e.g., by processor 604) one or more processes described herein. When processor 604 executes instructions stored in memory 606, processor 604 generally configures controller 106 (and more particularly processing circuit 602) to complete such activities.

In some embodiments, fire panel 12 includes a communications interface 608 (e.g., a USB port, a wireless transceiver, etc.) configured to receive and transmit data. Communications interface 608 may include wired or wireless communications interfaces (e.g., jacks, antennas, transmitters, receivers, transceivers, wire terminals, etc.) for conducting data communications external systems or devices. In various embodiments, the communications may be direct (e.g., local wired or wireless communications) or via a communications network (e.g., a WAN, the Internet, a cellular network, etc.). For example, communications interface 608 can include a USB port or an Ethernet card and port for sending and receiving data via an Ethernet-based communications link or network. In another example, communications interface 608 can include a Wi-Fi transceiver for communicating via a wireless communications network or cellular or mobile phone communications transceivers. In some embodiments, communications interface 608 facilitates wired or wireless communications between fire panel 12 and air sampling detector 24a (and/or air sampling detector 24b), smoke detector 22, temperature sensor 36, battery management system 18, fire suppression apparatus 20, BMS 14, emergency personnel 26, and alert device 32.

Referring still to FIG. 6, memory 606 is shown to include an off-gas manager 612, a fire suppression manager 614, an alert manager 610, and a battery manager 616. In some embodiments, off-gas manager 612 is configured to process or analyze sensor data or sensor signals received from air sampling detector 24a to determine if off-gas is present at any of battery racks 16 or to determine a concentration of off-gas within battery racks 16. In some embodiments, fire suppression manager 614 is configured to use the off-gas concentration and/or the detected presence of off-gas in battery racks 16 to determine if fire suppression apparatus 20 should be activated, to determine if battery management system 18 should be shut-off, to determine if an alert should be provided to BMS 14, emergency personnel 26, and/or alert device 32. In some embodiments, fire suppression manager 614 is configured to use sensor data obtained by smoke detector 22 and/or temperature sensor 36 in addition to the off-gas detection to determine if fire suppression apparatus 20 should be activated. Alert manager 610 is configured to cooperatively function with fire suppression manager 614 to provide an appropriate alert or alarm. Battery manager 616 is configured to use any of the outputs of fire suppression manager 614 (e.g., a shut-off command, a fire detection, a rise in temperature, etc.) to provide battery control signals to battery management system 18.

Referring still to FIG. 6, off-gas manager 612 is shown receiving the off-gas sensor signals from air sampling detector 24a and/or air sampling detector 24b. In some embodiments, off-gas manager 612 is configured to receive the off-gas sensor signals from air sampling detector 24a and/or air sampling detector 24b and determine if off-gas is present within the corresponding battery rack 16. In some embodiments, off-gas manager 612 provides fire suppression manager 614 with an indication of whether or not off-gas is present/detected within the corresponding battery rack 16 as well as which of battery racks 16 the indication corresponds to. For example, a binary decision variable dⱼ for the jth battery rack 16 may have a value of 1, indicating that off-gas is currently detected in the jth battery rack 16, or a value of 0, indicating that off-gas is not currently detected in the jth battery rack 16. In this case, off-gas manager 612 can provide a value of the decision variable d for each battery rack 16. For example, the first battery rack 16 may have an associated decision variable d₁, the second battery rack 16 may have an associated decision variable d₂, etc., and the nth battery rack 16 may have an associated decision variable dₙ.

In some embodiments, off-gas manager 612 is configured to use the off-gas sensor signals received from air sampling detector 24a to identify a concentration of off-gas in the associated battery rack 16. For example, off-gas manager 612 can determine a concentration Cⱼ of the jth battery rack 16. In this way, if n battery racks 16 are used, off-gas manager 612 can use the received off-gas sensor signals to identify values of C₁, C₂, . . . , Cₙ, where C₁ is the detected concentration of off-gas in the first battery rack 16, C₂ is the detected concentration of off-gas in the second battery rack 16, etc., and Cₙ is the detected concentration of off-gas in the nth battery rack 16. In some embodiments, the concentrations have values of parts per million (e.g., Cⱼ=off-gas ppm), a ratio of a volume V_{gas} of the detected off-gas to the volume of the air sample

$${V}_{sample} ( e . g . , {C}_{j} = \frac{{V}_{gas , j}}{{V}_{sample}} ) ,$$

a ratio of a mass_{gas} of the detected off-gas to mass of the air sample

$${m}_{sample} ( e . g . , {C}_{j} = \frac{{m}_{gas , j}}{{m}_{sample}} ) ,$$

etc. In some embodiments, the concentration indicates a ratio of an amount of the off-gas in the sample to the total amount of the air sample.

In some embodiments, air sampling detector 24b provides off-gas sensor signal(s) for detection of a concentration or presence of off-gas in ambient or surrounding areas. The concentration or presence of off-gas may indicate a reference or baseline concentration of off-gas. Off-gas manager 612 can compare concentrations of off-gas of the battery racks 16 (e.g., the concentration Cⱼ) to concentration of off-gas in the ambient or surrounding areas (e.g., an ambient concentration C_{amb}) to determine a difference (e.g., ΔCⱼ) between the concentration of off-gas at the battery racks 16 (e.g., Cⱼ) and the concentration of off-gas in the ambient or surrounding areas. In some embodiments, the difference ΔCⱼ may be used in place of the concentrations Cⱼ (e.g., by off-gas manager 612, by fire suppression manager 614, by alert manager 610, by battery manager 616, etc.).

In some embodiments, fire panel 12 is configured to monitor any of, or any combination of the concentrations Cⱼ, the ambient concentration C_{amb}, or the difference(s) ΔCⱼ in real-time. Fire panel 12 (e.g., off-gas manager 612) can be configured to detect changes in any of the of the concentrations Cⱼ, the ambient concentration C_{amb}, or the difference(s) ΔCⱼ of less than 1 ppm.

In some embodiments, off-gas manager 612 provides any of the concentrations C₁, C₂, . . . , Cₙ of the n battery racks 16 to fire suppression manager 614. Off-gas manager 612 can be configured to generate control signals for air sampling detector 24a (or for suction pumps 40) to draw air samples to air sampling detector 24a. In some embodiments, off-gas manager 612 modulates the suction on individual pipes that connect battery racks 16 to air sampling detector 24a. In this way, off-gas manager 612 can track which of battery racks 16 the air sample corresponds to, and can associate the detected concentration or presence of off-gas with the appropriate battery rack 16. For example, off-gas manager 612 may operate a first suction pump 40 to draw an air sample from the first battery rack 16, receive the off-gas sensor signals from air sampling detector 24a, and assign the detected concentration of off-gas in the air sample to the first battery rack 16 (e.g., C₁). Off-gas manager 612 can then provide the concentrations C₁, C₂, . . . , Cₙ of battery racks 16 and/or the binary decision variables b₁, b₂, bₙ to fire suppression manager 614.

Referring still to FIG. 6, fire suppression manager 614 is shown receiving the off-gas concentration (or the binary decision variables) from off-gas manager 612. In some embodiments, fire suppression manager 614 is configured to analyze the off-gas concentrations to identify if a fire is likely to occur in the near-future at any of battery racks 16. Fire suppression manager 614 can receive the concentrations from off-gas manager 612 and compare the concentrations to a threshold concentration value C_{threshold} In some embodiments, the threshold concentration value C_{threshold} is a predetermined value that indicates whether a significant amount of off-gas are present in battery rack 16. In some embodiments, C_{threshold} is equal to zero or substantially equal to zero, such that fire suppression manager 614 determines that a fire is likely to occur at battery rack 16 in response to any amount of off-gas being detected in battery rack 16.

In response to any of the concentrations C₁, C₂, . . . , Cₙ exceeding the threshold concentration value C_{threshold}, fire suppression manager 614 can determine that a fire is likely to occur in the near future at the corresponding battery rack 16. In response to determining that a fire is likely to occur in the near future at the corresponding battery rack 16, fire suppression manager 614 can generate activation signals (e.g., fire suppression release signals) and provide the activation signals to fire suppression apparatus 20 to activate fire suppression apparatus 20 and discharge the fire suppression agent to suppress or prevent the fire from occurring. If none of the concentrations of off-gas in any of battery racks 16 exceeds the threshold concentration value C_{threshold}, fire suppression manager 614 does not activate fire suppression apparatus 20 and continues periodically checking the concentrations of off-gas as provided by off-gas manager 612.

In some embodiments, fire suppression manager 614 is configured to receive smoke detection signals and temperature signals from smoke detector 22 and temperature sensor 36, respectively. Fire suppression manager 614 can use the smoke detection and the temperature at any of battery racks 16 to determine if a fire has occurred or is likely to occur. Fire suppression manager 614 can compare the temperature at each battery rack 16 to a corresponding threshold temperature to determine if a fire has occurred or if a fire is likely to occur in the near future. In some embodiments, fire suppression manager 614 activates fire suppression apparatus 20 in response to the temperature at any of battery racks 16 exceeding the threshold temperature value or in response to the smoke detection indicating that smoke is present in any of battery racks 16.

In some embodiments, fire suppression manager 614 receives sensed temperature values associated with each battery rack 16 from temperature sensor 36. Fire suppression manager 614 can determine a rate of change of the temperature \dot{T}_{rack} over time. In some embodiments, if the rate of change of the temperature \dot{T}_{rack} exceeds a corresponding temperature rate of change threshold value \dot{T}_{threshold} for a predetermined time duration Δt (e.g., if the temperature at one of battery racks 16 is increasing rapidly over the predetermined time duration), fire suppression manager 614 may determine that a fire is likely to occur at one of battery racks 16 and may activate fire suppression apparatus 20 to prevent the fire from occurring or to suppress if the fire if it has already occurred.

In this way, fire suppression manager 614 can use the off-gas concentrations, smoke detection, and temperature to preemptively activate fire suppression apparatus 20 to prevent a fire from occurring at battery racks 16. In some embodiments, fire suppression system 10 also includes an optical sensor configured to measure heat or light emitted by a fire. In this way, fire suppression manager 614 can receive sensor data from the optical sensor and use the sensor data to determine if a fire has occurred.

Fire suppression manager 614 can also provide a shut-off command to battery manager 616. In some embodiments, fire suppression manager 614 provides a shut-off command to battery manager 616 if activation signals are provided to fire suppression apparatus 20, or if fire suppression manager 614 determines that the temperature is increasing at a rate above the temperature rate of change threshold value. In this way, battery manager 616 may generate battery control signals to shut-off battery racks 16 concurrently with activating fire suppression apparatus 20 (e.g., in response to a fire being detected, or in response to fire suppression manager 614 determining that a fire is likely to occur in the near future). Likewise, fire suppression manager 614 can provide the shut-off command to battery manager 616 if the temperature at battery racks 16 exceeds a maximum allowable temperature (e.g., the threshold temperature value). In some embodiments, fire suppression manager 614 provides the shut-off command to battery manager 616 without providing activation signals to fire suppression apparatus 20. For example, if the temperature at battery racks 16 begins increasing at a rapid pace (e.g., above a corresponding rate of change threshold value) for at least a time interval or if the temperature at battery racks 16 exceeds the maximum allowable temperature, fire suppression manager 614 may provide the shut-off command to battery manager 616 without providing the activation signals to fire suppression apparatus 20. In this way, battery manager 616 may shut-off battery racks 16 without activation of fire suppression apparatus 20.

Battery manager 616 receives the shut-off command from fire suppression manager 614 and provides battery control signals to battery management system 18, battery racks 16, or a switch. In some embodiments, battery management system 18 shuts off battery racks 16 so that power cannot be drawn from the battery cells of battery racks 16 in response to receiving shut-off control signals. In some embodiments, all of battery racks 16 are shut off. In some embodiments, particular battery racks 16 are shut off which are associated with high temperatures (e.g., temperatures exceeding the maximum allowable temperature) or rapidly increasing temperatures (e.g., temperatures that are increasing at a rate greater than a maximum rate of change threshold).

Fire suppression manager 614 can also provide an indication to alert manager 610 regarding operations performed in response to detecting a fire or in response to determining that a fire is likely to occur in the near future. For example, if fire suppression manager 614 provides activation signals to fire suppression apparatus 20, fire suppression manager 614 may also notify alert manager 610 that fire suppression apparatus 20 has been activated. In some embodiments, if fire suppression manager 614 activates fire suppression apparatus 20 to preemptively suppress a fire at battery racks, fire suppression manager 614 also provides alert manager 610 with an indication that fire suppression apparatus 20 is being activated preemptively. Likewise, if fire suppression manager 614 activates fire suppression apparatus 20 due to a fire occurring at battery racks 16, fire suppression manager 614 may also notify alert manager 610 that fire suppression apparatus 20 was activated due to the occurrence of a fire. Additionally, fire suppression manager 614 can provide alert manager 610 with a notification of whether or not the shut-off command was provided to battery manager 616 or with a notification of which battery racks 16 were shut off.

Alert manager 610 receives the notifications of any of the operations of fire suppression manager 614 and provides an appropriate alert. Alert manager 610 can provide an alert to BMS 14, emergency personnel 26 (e.g., an SMS message, an email, an instant message, a notification, etc.), and/or alert device 32 (e.g., a visual alert, an aural alert, etc.). In some embodiments, alert manager 610 provides different alerts or provides alerts to certain devices/systems based on the notifications of the operations received from fire suppression manager 614. In some embodiments, the alerts provided to BMS 14, emergency personnel 26, and/or alert device 32 include the notifications received from fire suppression manager 614 and/or the reasons for why the various operations were performed. For example, alert manager 610 can alert BMS 14 that a fire was detected at the first battery rack 16 and that the battery racks 16 were shut off and fire suppression apparatus 20 has been activated in response to the fire. Likewise, alert manager 610 can alert BMS 14, emergency personnel, and/or alert device 32 that battery racks 16 were shut off due to high temperatures but that fire suppression apparatus 20 was not activated.

Alert device 32 can also be or include a display screen configured to provide a status of battery management system 18, temperature detection at battery racks 16, smoke detection in battery racks 16, off-gas detection in battery racks 16, rate of change of temperature at battery racks 16, etc. In some embodiments, alert device 32 is also configured to display a current status of fire suppression apparatus 20 (e.g., whether or not fire suppression apparatus 20 has been activated, a time at which fire suppression apparatus 20 was activated, a reason why fire suppression apparatus 20 was activated, etc.).

Advantageously, fire panel 12 is configured to monitor off-gas concentrations in battery racks 16 (e.g., that are positioned within storage container 68) and activate fire suppression apparatus 20 preemptively to reduce the likelihood of a fire occurring and to prevent thermal runaway. Since battery fires can be particularly difficult to extinguish after combustion, preemptively detecting and responding to fires by monitoring the off-gas emitted by the battery cells of battery racks 16 reduces the likelihood of a fire occurring, thereby reducing the likelihood that battery racks 16 or surrounding objects (e.g., storage container 68) are destroyed or damaged due to a fire occurrence.

### Battery Fire Suppression Process

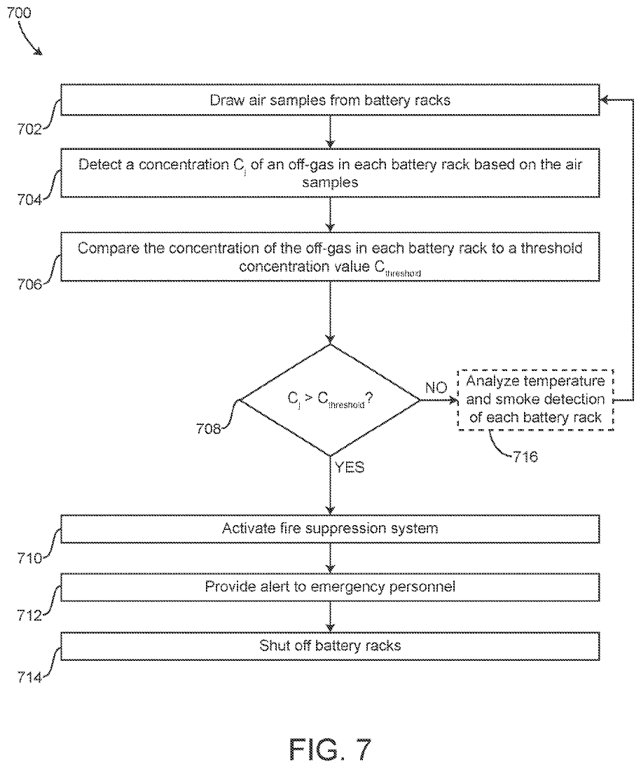

Referring now to FIG. 7, a process 700 for monitoring battery racks and preemptively responding to various conditions at the battery racks to prevent combustion is shown, according to some embodiments. Process 700 includes steps 702-716 and may be performed by fire suppression system 10, battery container system 50. Advantageously, process 700 can be performed to monitor off-gas emitted by failing battery cells and thereby prevent thermal runaway and combustion of the battery cells.

Process 700 includes drawing air samples from battery racks (step 702), according to some embodiments. In some embodiments, step 702 is performed by suction pumps 40 and fire panel 12. In some embodiments, step 702 is performed by off-gas manager 612 and/or air sampling detector 24a. Step 702 can be performed by operating suction pumps 40 to draw air samples from each of battery racks 16 through piping system 38 of storage container 68. In other embodiments, step 702 is performed by receiving air samples from within each of battery racks 16 if there is a forced airflow through battery racks 16. Step 702 can be performed by serially modulating suction pressure through various conduits that each fluidly couple air sampling detector 24a with a corresponding battery rack 16.

Process 700 includes detecting a concentration Cⱼ of an off-gas in each battery rack based on the air samples (step 704), according to some embodiments. In some embodiments, step 704 is performed by air sampling detector 24a. In some embodiments, step 704 includes identifying a concentration of one or more of a variety of gasses that are emitted by battery cells as they begin to fail. The concentration can be measured or detected in units of parts per million (ppm), percent concentration, a ratio between the volume of the off-gas and the air sample, etc. In some embodiments, off-gas manager 612 is configured to receive sensor signals from air sampling detector 24a and use the sensor signals to identify the concentration of off-gas in the air sample.

Process 700 includes comparing the concentration Cⱼ of the off-gas in each battery rack to a threshold concentration value C_{threshold} (step 706) and determining if the concentration Cⱼ of the off-gas in each battery rack exceeds the threshold concentration value C_{threshold} (step 708), according to some embodiments. In some embodiments, steps 706 and 708 are performed by fire suppression manager 614 to determine if fire suppression apparatus 20 should be activated. In some embodiments, the threshold concentration value C_{threshold} is a maximum allowable threshold value. Values above the threshold concentration value C_{threshold} can indicate that the battery cells of battery rack 16 are emitting off-gasses and are in the process of failing. In some embodiments, the threshold concentration value C_{threshold} has a value of zero. In some embodiments, the threshold concentration value C_{threshold} is a value determined based on empirical testing. Process 700 proceeds to step 710 in response to the concentration of the off-gas in battery rack 16 exceeding the threshold concentration value C_{threshold}, according to some embodiments. In some embodiments, process 700 proceeds to step 710 in response to the concentration of the off-gas in battery rack 16 being substantially equal to the threshold concentration value C_{threshold} In some embodiments, process 700 proceeds to step 716 (or returns to step 702) in response to the concentration of off-gas in battery rack 16 being less than the threshold concentration value C_{threshold}

Process 700 includes activating the fire suppression system (step 710) in response to the concentration or level of off-gas in battery rack 16 being greater than (or greater than or equal to) the threshold concentration value C_{threshold}, according to some embodiments. In some embodiments, step 710 includes activating fire suppression apparatus 20 to provide fire suppression agent to battery racks 16 (e.g., within storage container 64). In some embodiments, step 710 includes fluidly coupling agent container 78 with suppression nozzle 76 such that fire suppression agent can flow from agent container 78 to internal volume 64 of storage container 68 through suppression nozzle 76.

Process 700 includes providing an alert to emergency personnel (step 712), according to some embodiments. In some embodiments, step 712 includes providing the alert to BMS 14. In some embodiments, the alert includes an indication of whether or not fire suppression apparatus 20 has been activated and/or whether or not battery racks 16 have been shut-down. In some embodiments, step 712 is performed by alert manager 610. In some embodiments, step 712 includes operating alert device 32 to provide a visual and/or an aural alert. In this way, if off-gas is detected, the user can be alerted by operation of alert device 32, providing an alert to BMS 14, providing a text message, instant message, notification, etc., to emergency personnel 26, etc.

Process 700 includes shutting off the battery racks (step 714), according to some embodiments. In some embodiments, step 714 is performed by battery manager 616. In some embodiments, step 714 includes operating battery racks 16 such the battery cells do not provide power to an end user or for an end use. In some embodiments, any of steps 710-714 are performed concurrently. In some embodiments, the alert provided in step 712 includes an indication of a status of battery racks 16 (e.g., whether or not battery racks 16 are shut-off/deactivated).

Process 700 includes analyzing temperature and smoke detection of each battery rack (step 716), according to some embodiments. In some embodiments, step 716 includes receiving smoke detection and/or temperature sensor feedback from smoke detector 22 and/or temperature sensor 36. In some embodiments, step 716 is performed by fire suppression manager 614 and includes comparing the smoke detection or the temperature to a corresponding threshold value. In some embodiments, step 716 is optional. If the smoke detection and/or the temperature indicates a fire (e.g., if smoke is detected or if the temperature exceeds a threshold value), process 700 may proceed to step 710 and activate fire suppression apparatus 20 to suppress the fire. If the smoke detection and/or the temperature does not indicate a fire (e.g., if smoke is not detected and if the temperature does not exceed the threshold value), process 700 returns to step 702.

### Fire Suppression Apparatus

Referring to FIG. 8, a fire suppression system 810 is shown according to an exemplary embodiment. In one embodiment, fire suppression system 810 is a chemical fire suppression system. Fire suppression system 810 is configured to dispense or distribute a fire suppressant agent onto and/or nearby a fire, extinguishing the fire and preventing the fire from spreading. Fire suppression system 810 may be used alone or in combination with other types of fire suppression systems (e.g., a building sprinkler system, a handheld fire extinguisher, etc.). In some embodiments, multiple fire suppression systems 10 are used in combination with one another to cover a larger area (e.g., each in different rooms of a building). In a preferred embodiment, fire suppression system 810 is a gaseous fire suppression system that uses a gaseous fire suppression agent (e.g., an inert or chemical gaseous fire suppression agent).

Fire suppression system 810 may be used in a variety of different applications. Different applications may require different types of fire suppressant agent and different levels of mobility. Fire suppression system 810 is usable with a variety of different fire suppressant agents, such as powders, liquids, foams, or other fluid or flowable materials. Fire suppression system 810 may be used in a variety of stationary applications. By way of example, fire suppression system 810 is usable in kitchens (e.g., for oil or grease fires, etc.), in libraries, in data centers (e.g., for electronics fires, etc.), at filling stations (e.g., for gasoline or propane fires, etc.), or in other stationary applications. Alternatively, fire suppression system 810 may be used in a variety of mobile applications. By way of example, fire suppression system 810 may be incorporated into land-based vehicles (e.g., racing vehicles, forestry vehicles, construction vehicles, agricultural vehicles, mining vehicles, passenger vehicles, refuse vehicles, etc.), airborne vehicles (e.g., jets, planes, helicopters, etc.), or aquatic vehicles, (e.g., ships, submarines, etc.).

Referring again to FIG. 8, fire suppression system 810 includes a fire suppressant tank 812 (e.g., a vessel, container, vat, drum, tank, canister, pressure vessel, cartridge, or can, etc.). Fire suppressant tank 812 defines an internal volume 814 filled (e.g., partially, completely, etc.) with fire suppressant agent. In some embodiments, the fire suppressant agent is normally not pressurized (e.g., is near atmospheric pressure). Fire suppressant tank 812 includes an exchange section, shown as neck 816. Neck 816 permits the flow of expellant gas into internal volume 814 and the flow of fire suppressant agent out of internal volume 814 so that the fire suppressant agent may be supplied to a fire.

Fire suppression system 810 further includes a cartridge 820 (e.g., a vessel, container, vat, drum, tank, canister, pressure vessel, cartridge, or can, etc.). Cartridge 820 defines an internal volume 822 configured to contain a volume of pressurized expellant gas. The expellant gas may be an inert gas. In some embodiments, the expellant gas is air, carbon dioxide, or nitrogen. Cartridge 820 includes an outlet portion or outlet section, shown as neck 824. Neck 824 defines an outlet fluidly coupled to internal volume 822. Accordingly, the expellant gas may leave cartridge 820 through neck 824. Cartridge 820 may be rechargeable or disposable after use. In some embodiments where cartridge 820 is rechargeable, additional expellant gas may be supplied to internal volume 822 through neck 824.

Fire suppression system 810 further includes a valve, puncture device, or activator assembly, shown as actuator 830. Actuator 830 includes an adapter, a coupler, an interfacing member, a receiving member, an engagement member, etc., shown as receiver 832, that is configured to receive neck 824 of cartridge 820. Neck 824 is selectively coupled to the receiver 832 (e.g., through a threaded connection, etc.). Decoupling cartridge 820 from actuator 830 facilitates removal and replacement of cartridge 820 when cartridge 820 is depleted. Actuator 830 is fluidly coupled to neck 816 of fire suppressant tank 812 through a conduit, tubular member, pipe, fixed pipe, piping system, etc., shown as hose 834.

Actuator 830 includes an activation mechanism 836 configured to selectively fluidly couple internal volume 822 to neck 816. In some embodiments, activation mechanism 836 includes one or more valves that selectively fluidly couple internal volume 822 to hose 834. The valves may be mechanically, electrically, manually, or otherwise actuated. In some such embodiments, neck 824 includes a valve that selectively prevents the expellant gas from flowing through neck 824. Such a valve may be manually operated (e.g., by a lever or knob on the outside of cartridge 820, etc.) or may open automatically upon engagement of neck 824 with actuator 830. Such a valve facilitates removal of cartridge 820 prior to depletion of the expellant gas. In other embodiments, cartridge 820 is sealed, and activation mechanism 836 includes a pin, knife, nail, or other sharp object that actuator 830 forces into contact with cartridge 820. This punctures the outer surface of cartridge 820, fluidly coupling internal volume 822 with actuator 830. In some embodiments, activation mechanism 836 punctures cartridge 820 only when actuator 830 is activated. In some such embodiments, activation mechanism 836 omits any valves that control the flow of expellant gas to hose 834. In other embodiments, activation mechanism 836 automatically punctures cartridge 820 as neck 824 engages actuator 830.

Once actuator 830 is activated and cartridge 820 is fluidly coupled to hose 834, the expellant gas from cartridge 820 flows freely through neck 824, actuator 830, and hose 834 and into neck 816. The expellant gas forces fire suppressant agent from fire suppressant tank 812 out through neck 816 and into a conduit or hose, shown as pipe 840. In one embodiment, neck 816 directs the expellant gas from hose 834 to a top portion of internal volume 814. Neck 816 defines an outlet (e.g., using a syphon tube, etc.) near the bottom of fire suppressant tank 812. The pressure of the expellant gas at the top of internal volume 814 forces the fire suppressant agent to exit through the outlet and into pipe 840. In other embodiments, the expellant gas enters a bladder within fire suppressant tank 812, and the bladder presses against the fire suppressant agent to force the fire suppressant agent out through neck 816. In yet other embodiments, pipe 840 and hose 834 are coupled to fire suppressant tank 812 at different locations. By way of example, hose 834 may be coupled to the top of fire suppressant tank 812, and pipe 840 may be coupled to the bottom of fire suppressant tank 812. In some embodiments, fire suppressant tank 812 includes a burst disk that prevents the fire suppressant agent from flowing out through neck 816 until the pressure within internal volume 814 exceeds a threshold pressure. Once the pressure exceeds the threshold pressure, the burst disk ruptures, permitting the flow of fire suppressant agent. Alternatively, fire suppressant tank 812 may include a valve, a puncture device, or another type of opening device or activator assembly that is configured to fluidly couple internal volume 814 to pipe 840 in response to the pressure within internal volume 814 exceeding the threshold pressure. Such an opening device may be configured to activate mechanically (e.g., the force of the pressure causes the opening device to activate, etc.) or the opening device may include a separate pressure sensor in communication with internal volume 814 that causes the opening device to activate.

Pipe 840 is fluidly coupled to one or more outlets or sprayers (e.g., nozzles, sprinkler heads, discharge devices, dispersion devices, etc.), shown as nozzles 842. The fire suppressant agent flows through pipe 840 and to nozzles 842. Nozzles 842 each define one or more apertures, through which the fire suppressant agent exits, forming a spray of fire suppressant agent that covers a desired area. The sprays from nozzles 842 then suppress or extinguish fire within that area. The apertures of nozzles 842 may be shaped to control the spray pattern of the fire suppressant agent leaving nozzles 842. Nozzles 842 may be aimed such that the sprays cover specific points of interest (e.g., a specific piece of restaurant equipment, a specific component within an engine compartment of a vehicle, etc.). Nozzles 842 may be configured such that all of nozzles 842 activate simultaneously, or nozzles 842 may be configured such that only nozzles 842 near the fire are activated.

Fire suppression system 810 further includes an automatic activation system 850 that controls the activation of actuator 830. Automatic activation system 850 is configured to monitor one or more conditions and determine if those conditions are indicative of a nearby fire. Upon detecting a nearby fire, automatic activation system 850 activates actuator 830, causing the fire suppressant agent to leave nozzles 842 and extinguish the fire.

In some embodiments, actuator 830 is controlled mechanically. As shown in FIG. 8, automatic activation system 850 includes a mechanical system including a tensile member (e.g., a rope, a cable, etc.), shown as cable 852, that imparts a tensile force on actuator 830. Without this tensile force, actuator 830 will activate. Cable 852 is coupled to a fusible link 854, which is in turn coupled to a stationary object (e.g., a wall, the ground, etc.). The fusible link 854 includes two plates that are held together with a solder alloy having a predetermined melting point. A first plate is coupled to cable 852, and a second plate is coupled to the stationary object. When the ambient temperature surrounding the fusible link 854 exceeds the melting point of the solder alloy, the solder melts, allowing the two plates to separate. This releases the tension on cable 852, and actuator 830 activates. In other embodiments, automatic activation system 850 is another type of mechanical system that imparts a force on actuator 830 to activate actuator 830. Automatic activation system 850 may include linkages, motors, hydraulic or pneumatic components (e.g., pumps, compressors, valves, cylinders, hoses, etc.), or other types of mechanical components configured to activate actuator 830. Some parts of automatic activation system 850 (e.g., a compressor, hoses, valves, and other pneumatic components, etc.) may be shared with other parts of fire suppression system 810 (e.g., manual activation system 860) or vice versa.

Actuator 830 may additionally or alternatively be configured to activate in response to receiving an electrical signal from automatic activation system 850. Referring to FIG. 8, automatic activation system 850 includes a controller 856 that monitors signals from one or more fire detectors or sensors, shown as temperature sensor 858 (e.g., thermocouples, resistance temperature detectors, etc.). Controller 856 may use the signals from the temperature sensor 858 to determine if an ambient temperature has exceeded a threshold temperature. Upon determining that the ambient temperature has exceeded the threshold temperature, controller 856 provides an electrical signal to actuator 830. Actuator 830 then activates in response to receiving the electrical signal.

Fire suppression system 810 further includes a manual activation system 860 that controls the activation of actuator 830. Manual activation system 860 is configured to activate actuator 830 in response to an input from an operator. Manual activation system 860 may be included in addition to automatic activation system 850. Both automatic activation system 850 and manual activation system 860 may activate actuator 830 independently. By way of example, automatic activation system 850 may activate actuator 830 regardless of any input from manual activation system 860.

As shown in FIG. 8, manual activation system 860 includes a mechanical system including a tensile member (e.g., a rope, a cable, etc.), shown as cable 862, coupled to actuator 830. Cable 862 is coupled to a human interface device (e.g., a button, a lever, a switch, a knob, a pull ring, etc.), shown as button 864. Button 864 is configured to impart a tensile force on cable 862 when pressed, and this tensile force is transferred to actuator 830. Actuator 830 activates upon experiencing the tensile force. In other embodiments, manual activation system 860 is another type of mechanical system that imparts a force on actuator 830 to activate actuator 830. Manual activation system 860 may include linkages, motors, hydraulic or pneumatic components (e.g., pumps, compressors, valves, cylinders, hoses, etc.), or other types of mechanical components configured to activate actuator 830.

Actuator 830 may additionally or alternatively be configured to activate in response to receiving an electrical signal from manual activation system 860. As shown in FIG. 8, button 864 is operably coupled to controller 856. Controller 856 may be configured to monitor the status of a human interface device or user input device (e.g., engaged, disengaged, etc.). Upon determining that the human interface device is engaged, the controller provides an electrical signal to activate actuator 830. By way of example, controller 856 may be configured to monitor a signal from button 864 to determine if button 864 is pressed. Upon detecting that button 864 has been pressed, controller 856 sends an electrical signal to actuator 830 to activate actuator 830.

Automatic activation system 850 and manual activation system 860 are shown to activate actuator 830 both mechanically (e.g., though application of a tensile force through cables, through application of a pressurized liquid, through application of a pressurized gas, etc.) and electrically (e.g., by providing an electrical signal). It should be understood, however, that automatic activation system 850 and/or manual activation system 860 may be configured to activate actuator 830 solely mechanically, solely electrically, or through some combination of both. By way of example, automatic activation system 850 may omit controller 856 and activate actuator 830 based on the input from the fusible link 854. By way of another example, automatic activation system 850 may omit the fusible link 854 and activate actuator 830 using an input from controller 856.

Referring further to FIG. 8, fire suppression system 810 further includes a canister monitoring system 100. Canister monitoring system 100 can be configured to monitor a status of fire suppression system 810 (e.g., to monitor a level of fire suppressant agent in fire suppressant tank 812, to monitor pressure of fire suppressant tank 812 and/or cartridge 820, to monitor placement of installed components of fire suppression system 810, etc.).

In some embodiments, fire suppression apparatus 20 is a component of fire suppression system 810. Fire suppression apparatus 20 can include any of the components or devices of fire suppression system 810. For example, fire suppressant tank 812, cartridge 820, hose 834, actuator 830, pipe 840, and nozzles 842 may be fire suppression apparatus 20.

### Configuration of Exemplary Embodiments

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, and/or illustrations of possible embodiments (and such terms are not intended to connote that such embodiments are necessarily extraordinary or superlative examples).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. Such members may be coupled mechanically, electrically, and/or fluidly.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire suppression system as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

What is claimed is:

1. A modular fire suppression unit comprising:
a housing;
an off-gas detector provided within the housing and configured to obtain air samples and detect a presence of off-gas in each air sample;
a fire suppression apparatus provided within the housing and configured to provide a fire suppression agent to a space; and
a controller provided within the housing and configured to:
receive signals from the off-gas detector indicating whether off-gas is detected in each of the air samples; and
activate the fire suppression apparatus to provide the fire suppression agent to the space in response to detecting off-gas in one or more of the air samples;
wherein the modular fire suppression unit is configured to be coupled to a sidewall of an enclosure.

2. The modular fire suppression unit of claim 1, wherein the fire suppression apparatus, the controller, and the off-gas detector are positioned within the housing.

3. The modular fire suppression unit of claim 1, further comprising a plurality of the off-gas detectors, wherein each of the plurality of the off-gas detectors is configured to detect the presence of off-gas in a corresponding one of one or more battery racks in the enclosure.

4. The modular fire suppression unit of claim 1, wherein the off-gas detector is configured to draw an air sample from each of a plurality of battery racks positioned within the enclosure serially;
wherein the off-gas detector is configured to fluidly couple with the plurality of battery racks through a piping system, wherein the piping system comprises one or more tubular members that each fluidly couple the off-gas detector with a corresponding one of the plurality of battery racks
wherein the controller is configured to operate one or more suction pumps to draw the air sample from each of the plurality of battery racks through the piping system to draw a first air sample from a first one of the plurality of battery racks at a first time, and a second air sample from a second one of the plurality of battery racks at a second time.

5. The modular fire suppression unit of claim 1, wherein the off-gas detector is configured to detect presence or concentration of any of a lithium-ion battery off-gas, carbon dioxide, methane, ethane, hydrogen, oxygen, nitrogen oxides, volatile organic compounds, ash, soot, hydrogen sulfide, sulfur oxides, ammonia, chlorine, propane, ozone, ethanol, hydrocarbons, hydrogen cyanide, combustible cases, flammable gases, toxic gases, corrosive gases, oxidizing gases, or an electrolyte vapor in the air sample.

6. The modular fire suppression unit of claim 1, wherein the controller is configured to:
receive signals from the off-gas detector indicating a concentration of off-gas in the air sample;
compare the concentration of off-gas to a threshold value; and
activate the fire suppression apparatus in response to the concentration of off-gas in the air sample exceeding the threshold value.

7. A fire suppression system comprising:
an enclosure comprising sidewalls and an internal volume defined within the sidewalls;
one or more battery racks positioned within the enclosure; and
a modular fire suppression assembly comprising:
an off-gas detector configured to obtain air samples from each of the one or more battery racks and detect a presence of off-gas in each of the one or more battery racks;
a fire suppression apparatus configured to provide a fire suppression agent to the internal volume of the enclosure; and
a controller configured to:
receive signals from the off-gas detector indicating whether off-gas is detected in each of the one or more battery racks; and
activate the fire suppression apparatus to provide the fire suppression agent to the internal volume of the enclosure.

8. The fire suppression system of claim 7, wherein the enclosure is any of a shipping container or a storage container and comprises a vent configured to selectively fluidly couple the internal volume of the enclosure with an external environment.

9. The fire suppression system of claim 7, further comprising:
a plurality of the off-gas detectors, wherein each of the plurality of the off-gas detectors is configured to detect the presence of off-gas in a corresponding one of the one or more battery racks and the off-gas detector is configured to draw an air sample from each of the battery racks serially; and
a piping system, wherein the piping system comprises one or more tubular members that each fluidly couple the off-gas detector with a corresponding one of the one or more battery racks and the controller is configured to operate one or more suction pumps to draw a first air sample from a first one of the one or more battery racks at a first time, and a second air sample from a second one of the one or more battery racks at a second time.

10. The fire suppression system of claim 7, wherein the off-gas detector is configured to detect presence or concentration of any of a lithium-ion battery off-gas, carbon dioxide, methane, ethane, hydrogen, oxygen, nitrogen oxides, volatile organic compounds, ash, soot, hydrogen sulfide, sulfur oxides, ammonia, chlorine, propane, ozone, ethanol, hydrocarbons, hydrogen cyanide, combustible cases, flammable gases, toxic gases, corrosive gases, oxidizing gases, or an electrolyte vapor in the air samples.

11. The fire suppression system of claim 7, wherein the controller is configured to:
receive signals from the off-gas detector indicating a concentration of off-gas in one or more of the battery racks;
compare the concentration of off-gas to a threshold value; and
activate the fire suppression apparatus in response to the concentration of off-gas in the battery racks exceeding the threshold value.

12. The fire suppression system of claim 7, wherein the controller is configured to shut-off the one or more battery racks in response to detecting off-gas in the one or more battery racks.

13. The fire suppression system of claim 7, wherein the controller is configured to alert emergency personnel in response to detecting off-gas in one or more of the battery racks.

14. The fire suppression system of claim 7, wherein the controller is configured to operate a visual alert device or an aural alert device in response to detecting off-gas in one or more of the battery racks.

15. The fire suppression system of claim 7, further comprising an HVAC system, wherein the off-gas detector is positioned in an air stream of the HVAC system to reduce a number of off-gas detectors.

16. The fire suppression system of claim 15, wherein the controller is configured to operate the HVAC system to open external vents to circulate air into the enclosure to prevent a buildup of off-gases from the one or more battery racks.

17. The fire suppression system of claim 15, wherein the controller is configured to operate the HVAC system to reduce a pressure within the enclosure when the fire suppression apparatus is activated.

18. A fire suppression system comprising:
an enclosure comprising sidewalls and an internal volume defined within the sidewalls;
one or more battery racks positioned within the enclosure;
a modular fire suppression assembly comprising sidewalls and an internal volume, wherein the modular fire suppression assembly is coupled with sidewalls of the enclosure, wherein the modular fire suppression assembly comprises:
an off-gas detector configured to obtain air samples from each of the one or more battery racks and detect a presence of off-gas in each of the one or more battery racks;
a fire suppression apparatus configured to provide a fire suppression agent to the internal volume of the enclosure and the internal volume of the modular fire suppression assembly; and
a controller configured to:
receive signals from the off-gas detector indicating whether off-gas is detected in each of the one or more battery racks; and
activate the fire suppression apparatus to provide the fire suppression agent to the internal volume of the enclosure.

19. The fire suppression system of claim 18, wherein the off-gas detector is configured to detect a presence of off-gas in any of the one or more battery racks within five seconds of the off-gas being present.

20. The fire suppression system of claim 18, further comprising an ambient off-gas detector configured to monitor a presence or concentration of off-gas outside of the one or more battery racks, wherein the controller is configured to receive signals from the ambient off-gas detector and determine a difference between an ambient concentration of off-gas outside of the one or more battery racks and a concentration of off-gas within the one or more battery racks.
